(19) United States
(12) Patent Application Publication
(10) Pub. No.: US 2026/0259352 A1
(43) Pub. Date: Sep. 3, 2026

(54) ANTIREFLECTIVE GLASS CERAMIC ARTICLES AND METHODS OF MAKING THE SAME

(71) Applicant: CORNING INCORPORATED, CORNING, NY (US)

(72) Inventors: Jaymin Amin, Corning, NY (US); Timothy Dimond, Corning, NY (US); Janette Dawn Hevner, Addison, NY (US); Yuhui Jin, Painted Post, NY (US); Galan Gregory Moore, Henrietta, NY (US); Sarah Elizabeth Roberts, Painted Post, NY (US); Meng Shang, Painted Post, NY (US); Fred Douglas Woodall, II, Elmira, NY (US)

(21) Appl. No.: 19/549,107

(22) Filed: Feb. 25, 2026

Related U.S. Application Data
(60) Provisional application No. 63/764,589, filed on Feb. 28, 2025.

(51) Int. Cl. G02B 1/11; C03C 10/00; C03C 15/00; C03C 21/00; G02B 1/02; G02B 1/18

(52) U.S. Cl. CPC G02B 1/11; C03C 10/0027; C03C 15/00; C03C 21/002; G02B 1/02; G02B 1/18

(57) ABSTRACT

An anti-reflective glass-ceramic article is described herein comprising a glass-ceramic body comprising a first major surface, a second major surface opposite the first major surface, and a refractive index-modified layer positioned adjacent the first major surface and extending into a thickness of the glass-ceramic body. Within the refractive index-modified layer at a depth of 25 nm into the glass-ceramic body from the first major surface is present a first glass-ceramic composition having a first refractive index and a first crystallinity. At a midpoint depth between the first major surface and the second major surface a second glass-ceramic composition is present having a second refractive index and a second crystallinity. The first refractive index may be at least 0.01 less than the second refractive index. The first crystallinity may be about 50% to about 90% of the second crystallinity.

### CLAIM OF PRIORITY

This application claims the benefit of priority under 35 U.S.C. § 119 of U.S. Provisional Application Ser. No. 63/764,589, filed on Feb. 28, 2025, the contents of which is incorporated herein by reference in its entirety.

### FIELD

This disclosure relates to glass-ceramic articles, methods for modifying glass-ceramic articles, and consumer electronic comprising the same.

### BACKGROUND

Portable electronic devices, such as, smartphones, tablets, and wearable devices (such as, for example, watches and fitness trackers) utilize glass-based materials. For example, screens and back covers on such portable electronic devices may be made of glass-ceramic materials. Additionally, other portions of the housing may include glass-ceramic articles. Coatings and other surface treatments may be used to enhance glass-ceramic materials, such as antireflective properties. However, coatings may have optical limitations, lack durability, and may be difficult and/or costly to apply.

Accordingly, a need exists for glass-ceramic materials with optical characteristics and durability, and methods of producing such materials. This need and other needs are addressed by the present disclosure.

### SUMMARY

In one or more embodiments, an anti-reflective glass-ceramic article may comprise a glass-ceramic body. The glass-ceramic body may comprise a first major surface, a second major surface opposite the first major surface, and a refractive index-modified layer positioned adjacent the first major surface and extending into a thickness of the glass-ceramic body. Within the refractive index-modified layer at a depth of 25 nm into the glass-ceramic body from the first major surface is present a first glass-ceramic composition having a first refractive index and a first crystallinity. At a midpoint depth between the first major surface and the second major surface a second glass-ceramic composition is present having a second refractive index and a second crystallinity. The first refractive index may be at least 0.01 less than the second refractive index. The first crystallinity may be about 50% to about 90% of the second crystallinity.

In one or more embodiments, a method of making an anti-reflective glass-ceramic article, the method comprising contacting a glass-ceramic body with a leaching composition comprising one or more non-hydrofluoric acids. The glass-ceramic body may comprise a first major surface, a second major surface opposite the first major surface, and a refractive index-modified layer positioned adjacent the first major surface and extending into a thickness of the glass-ceramic body. Within the refractive index-modified layer at a depth of 25 nm into the glass-ceramic body from the first major surface is present a first glass-ceramic composition having a first refractive index and a first crystallinity. At a midpoint depth between the first major surface and the second major surface a second glass-ceramic composition is present having a second refractive index and a second crystallinity. The first refractive index may be at least 0.01 less than the second refractive index. The first crystallinity may be about 50% to about 90% of the second crystallinity.

In one or more embodiments, a consumer electronic product may comprise a housing and electrical components. The housing may comprise a front surface, a back surface and side surfaces. The electrical components may be at least partially within the housing. The electrical components may comprise a controller, a memory, and a display. The display may be at or adjacent to the front surface of the housing. A cover substrate may be disposed over the display. At least one of a portion of the housing or the display may comprise an anti-reflective glass-ceramic article. The anti-reflective glass-ceramic article may comprise a glass-ceramic body. The glass-ceramic body may comprise a first major surface, a second major surface opposite the first major surface, and a refractive index-modified layer positioned adjacent the first major surface and extending into a thickness of the glass-ceramic body. Within the refractive index-modified layer at a depth of 25 nm into the glass-ceramic body from the first major surface may be present a first glass-ceramic composition having a first refractive index and a first crystallinity. At a midpoint depth between the first major surface and the second major surface a second glass-ceramic composition may be present having a second refractive index and a second crystallinity. The first refractive index may be at least 0.01 less than the second refractive index. The first crystallinity may be about 50% to about 90% of the second crystallinity.

Additional features and advantages will be set forth in the detailed description which follows, and in part will be readily apparent to those skilled in the art from that description or recognized by practicing the embodiments as described herein, including the detailed description which follows, the claims, as well as the appended drawings.

### BRIEF DESCRIPTION OF THE DRAWINGS

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments, wherein:

FIG. 1 schematically depicts a cross-sectional view of an anti-reflective glass-ceramic article, according to one or more embodiments described herein;

FIGS. 2A and 2B schematically depict a glass-ceramic article prior to leaching (a) and after leaching (b);

FIGS. 3A, 3B, and 3C graphically depicts SIMS depth profiles for anti-reflective glass-ceramic articles according to one or more embodiments described herein;

FIGS. 4A, 4B, and 4C schematically depict a cross-sectional view of (a) a glass-ceramic article without a refractive index-modified layer, (b) a glass-ceramic article with a refractive index-modified layer adjacent to the first major surface, and (c) a glass-ceramic article with an anti-reflective coating layer and no refractive index-modified layer, during a mechanical scratch event, according to one or more embodiments described herein;

FIG. 5 schematically depicts a cross-sectional view of an anti-reflective glass-ceramic article that also includes an ion-exchanged layer, according to one or more embodiments described herein;

FIG. 6 schematically depicts a cross-sectional view of an anti-reflective glass-ceramic article that also includes an easy-to-clean coating layer disposed on the first major surface of the anti-reflective glass-ceramic article, according to one or more embodiments described herein;

FIG. 7A is a plan view of an exemplary electronic device incorporating an article, according to one or more embodiments described herein;

FIG. 7B is a perspective view of the exemplary electronic device of FIG. 7A, according to one or more embodiments described herein;

FIG. 8A graphically depicts the contact angle of a test liquid following a certain number of abrasion cycles for glass-ceramic articles according to one or more embodiments described herein; and

FIG. 8B graphically depicts the contact angle of a test liquid following a certain number of abrasion cycles for glass-ceramic articles according to one or more embodiments described herein.

### DETAILED DESCRIPTION

Described herein are anti-reflective glass ceramic articles, methods for making such, and consumer electronic products that include the same. According to one or more embodiments, the usability of a glass-ceramic article in an electronic device can be related to the total amount of reflectance in the article. Antireflective coatings have been widely used to enhance the display readability and improve the aesthetic appearance of display and non-display glass-ceramic articles. The antireflective coating typically is made of a multi-layer thin film material that conforms to the base material surface. However, many current antireflective coatings require precise coating application in a cleanroom environment, a costly process having slow throughput, and the coating is susceptible to delamination from the base material during a mechanical scratch events leading to an impaired antireflective function and visible cosmetic defects on the article. The embodiments of the glass-ceramic articles disclosed herein provide relatively durable glass-ceramic articles having antireflective properties without use of a coating. According to embodiments presently disclosed, the glass-ceramic article may include a refractive index-modified layer that has a different refractive index than the bulk glass-ceramic body. Such refractive index-modified layer may be formed by leaching processes utilizing at least non-HF acid as a component of the leachant. Such embodiment enable anti-reflectivity of the glass-ceramic article without the use of a coating.

In the following detailed description, for purposes of explanation and not limitation, example embodiments disclosing specific details are set forth to provide a thorough understanding of various principles of the present disclosure. However, it will be apparent to one having ordinary skill in the art, having had the benefit of the present disclosure, that the present disclosure may be practiced in other embodiments that depart from the specific details disclosed herein. Moreover, descriptions of well-known devices, methods and materials may be omitted so as not to obscure the description of various principles of the present disclosure. Finally, wherever applicable, like reference numerals refer to like elements.

Ranges can be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

Directional terms as used herein—for example “up,” “down,” “right,” “left,” “front,” “back,” “top,” “bottom”—are made only with reference to the figures as drawn and are not intended to imply absolute orientation.

Unless otherwise expressly stated, it is in no way intended that any method set forth herein be construed as requiring that its steps be performed in a specific order. Accordingly, where a method claim does not actually recite an order to be followed by its steps, or it is not otherwise specifically stated in the claims or descriptions that the steps are to be limited to a specific order, it is in no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

As used herein, the singular forms “a,” “an” and “the” include plural referents unless the context clearly dictates otherwise. Thus, for example, reference to a “component” includes aspects having two or more such components, unless the context clearly indicates otherwise.

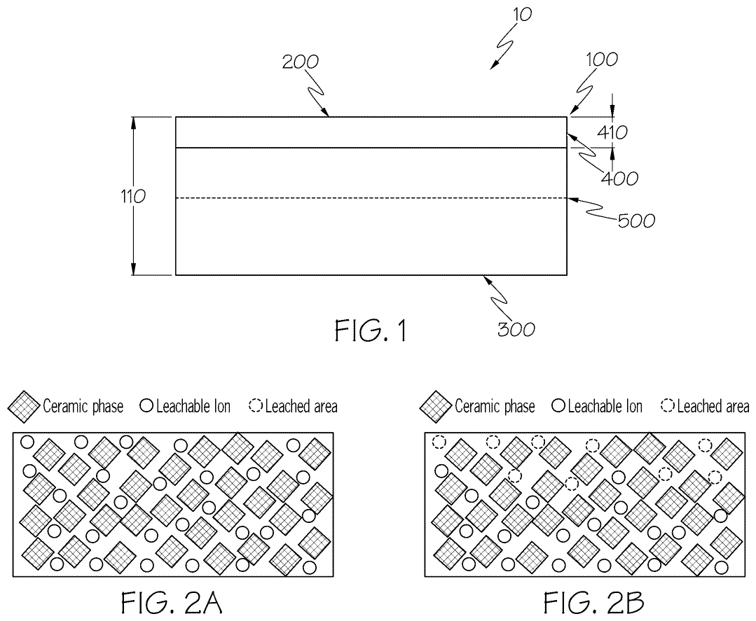

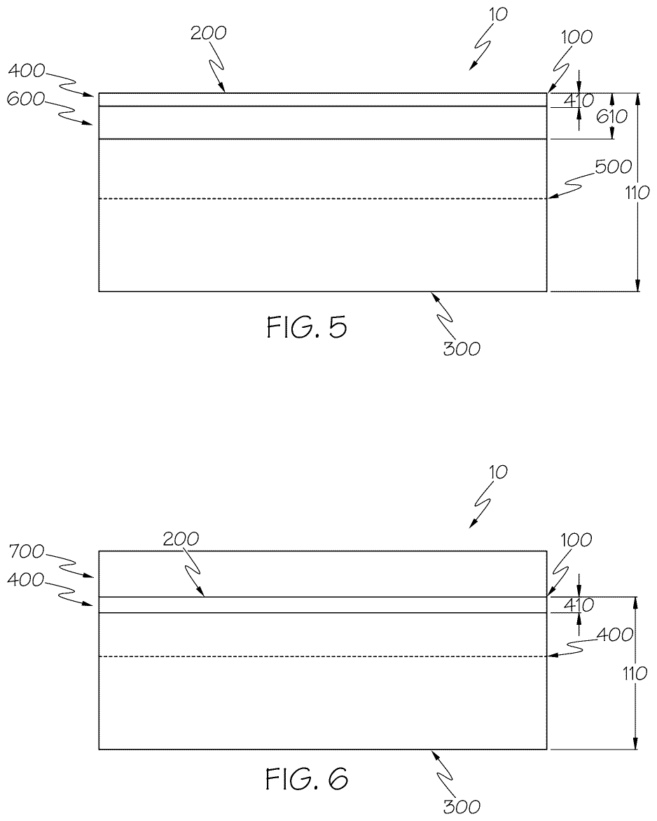

In embodiments described herein, as shown in FIG. 1, the anti-reflective glass-ceramic article 10 comprises a glass-ceramic body 100 comprising a first major surface 200, a second major surface 300 opposite the first major surface 200, and a refractive index-modified layer 400 positioned adjacent the first major surface 200 and extending into a thickness 410 of the glass-ceramic body 100. The glass-ceramic body has a midpoint depth 500 that is equidistant from the first major surface 200 and second major surface 300. While not depicted, the anti-reflective glass-ceramic article 10 may comprise a second refractive index-modified layer 400 adjacent the second major surface 300. Further embodiments of the anti-reflective glass-ceramic article 10 are depicted in FIGS. 5 and 6, described hereinbelow, and these embodiments can be combined with those of FIG. 1, or each other, as would be readily apparent to those skilled in the art.

As described herein, the anti-reflective glass-ceramic article 10 may comprise a glass-ceramic body 100, which consists of glass-ceramic. As used herein the term “glass-ceramic” refers to an inorganic material with amorphous and crystalline portions.

The glass-ceramic body 100 of the anti-reflective glass-ceramic article may be formed from man-made materials and/or naturally occurring materials (e.g., quartz). In some specific embodiments, the glass-ceramic body 100 may specifically exclude polymeric, plastic and/or metal substrates. The glass-ceramic body 100 may be characterized as an alkali-including substrate (i.e., the substrate includes one or more alkalis).

According to an embodiment, the glass-ceramic body 100 may consist essentially of the following composition: 68-72 mol % SiO₂; 3-5 mol % Al₂O₃; 0.6-1.2 mol % P₂O₅; 0-5 mol % B₂O₃; 17-25 mol % Li₂O; 0.01-1.7 mol % Na₂O; 0.01-0.5 mol % K₂O; 1.5-3 mol % ZrO₂; 0.01-0.1 mol % SnO₂; 0.01-0.1 mol % HfO₂; and 0.01-0.5 mol % Fe₂O₃ (exemplary compositions are listed below in Table 1, as measured prior to any ceramming step).

In one or more embodiments, the glass-ceramic body 100 may include one or more glass-ceramic materials. In one or more embodiments, the glass-ceramic body 100 as a glass-ceramic material may comprise one or more crystalline phases such as lithium disilicate (Li₂Si₂O₅), lithium metasilicate, petalite (LiAlSi₄O₁₀), beta quartz, and/or beta spodumene, as potentially combined with residual glass in the structure. In an embodiment, the glass-ceramic body 100 may comprise a disilicate phase. In another implementation, the glass-ceramic body 100 may comprise a disilicate phase and a petalite phase. According to an embodiment, the glass-ceramic body 100 may have a crystallinity of at least about 40% by weight. In some implementations, the glass-ceramic body 100 at the thickness midpoint (i.e., in the bulk of the body) may have a crystallinity of at least about 40%, 45%, 50%, 55%, 60%, 65%, 70%, 75%, 80%, 85%, or greater (by weight), with the residual as a glass phase. Further, according to some embodiments, each of the crystalline phases of the glass-ceramic body 100 may have an average crystallite size of less than 100 nm, less than 75 nm, less than 50 nm, less than 40 nm, less than 30 nm, and all crystallite sizes within or less than these levels. According to one exemplary embodiment, the glass-ceramic body 100 comprises lithium disilicate and petalite phases with 40-50 wt. % lithium disilicate (Li₂Si₂O₅), 35-45 wt. % petalite (LiAlSi₄O₁₀), <2 wt. % of other phases, and the remainder as residual glass (e.g., 10-21 wt. % glass) (exemplary phase assemblages are listed below in Table 2). Unless otherwise noted, all phase assemblage amounts and values are measured through X-ray diffraction (XRD) using a Rietveld analysis.

TABLE 1
Exemplary glass-ceramic substrate compositions

| Composition | | | |
|---|---|---|---|
| (mol %) | Ex. A | Ex. B | Ex. C |
| SiO₂ | 70.39 | 70.77 | 68.98 |
| Al₂O₃ | 4.21 | 4.21 | 4.03 |
| P₂O₅ | 0.85 | 0.85 | 1.01 |
| Li₂O | 21.16 | 21.98 | 22.31 |
| Na₂O | 1.50 | 0.06 | 0.07 |
| K₂O | 0.13 | 0.07 | 0.07 |
| ZrO₂ | 1.71 | 2.01 | 2.78 |
| CaO | 0.01 | 0.02 | 0.71 |
| Fe₂O₃ | 0.02 | 0.02 | 0.02 |
| HfO₂ | 0.02 | 0.02 | 0.03 |
| SnO₂ | 0.01 | 0.01 | 0.01 |

TABLE 2
Phase assemblages of exemplary glass-
ceramic substrate compositions (XRD)

| | | lithium disilicate | petalite | |
|---|---|---|---|---|
| | Glass | (Li₂Si₂O₅) | (LiAlSi₄O₁₀) | other phases |
| Material | (wt %) | (wt %) | (wt %) | (wt %) |
| Ex. A | 19 | 43 | 38 | <2% |
| Ex. B | 12 | 45 | 43 | <2% |
| Ex. C | 13 | 44 | 42 | <2% |

According to one or more embodiments, the glass-ceramic body 100 according to one or more embodiments may have a total thickness 110 from the first major surface 200 to the second major surface 300 ranging from about 100 μm to about 5 mm. Example glass-ceramic body 100 total thicknesses range from 100 microns to 150 microns, from 150 microns to 200 microns, from 200 microns to 250 microns, from 250 microns to 300 microns, from 300 microns to 350 microns, from 350 microns to 400 microns, from 400 microns to 450 microns, from 450 microns to 500 microns, from 500 microns to 550 microns, from 550 microns to 600 microns, from 600 microns to 650 microns, from 650 microns to 700 microns, from 700 microns to 750 microns, from 750 microns to 800 microns, from 800 microns to 850 microns, from 850 microns to 900 microns, from 900 microns to 950 microns, from 950 microns to 1000 microns (1 mm), or any combination of one or more of these ranges. In additional embodiments, glass-ceramic body 100 total thicknesses may range from 1.0 mm to 1.25 mm, from 1.25 mm to 1.5 mm, from 1.5 mm to 1.75 mm, from 1.75 mm to 2.0 mm, from 2.0 mm to 2.25 mm, from 2.25 mm to 2.5 mm, from 2.5 mm to 2.75 mm, from 2.75 mm to 3.0 mm, from 3.0 mm to 3.25 mm, from 3.25 mm to 3.5 mm, from 3.5 mm to 3.75 mm, from 3.75 mm to 4.0 mm, from 4.0 mm to 4.25 mm, from 4.25 mm to 4.5 mm, from 4.5 mm to 4.75 mm, from 4.75 mm to 5.0 mm, or any combination of one or more of these ranges.

As shown in FIG. 1, the refractive index-modified layer 400 may be positioned adjacent to the first major surface 200 and extend into a thickness 410 of the glass-ceramic body 100. The refractive index-modified layer 400 may extend into the glass-ceramic body 100 to a depth of about 1 micron or less, or 500 nm or less, or 400 nm or less, as measured from the first major surface 200. In general, the thickness 410 may be determined by SIMS analysis where the depth where leaching stops is the thickness 410 of the refractive index-modified layer 400. However, as is shown in the Examples, this thickness 410 is generally gradual and sometimes difficult to exactly decipher.

As used herein, the term “refractive index-modified layer” (400) refers to a layer of the glass-ceramic body 100 having a reduced refractive index when compared to the bulk of the glass-ceramic body 100, such as the bulk measured at a midpoint of the glass-ceramic body 100. The refractive index-modified layer 400 may be characterized as having a reduced concentration of alkali metal ions and/or zirconium ions as compared to the bulk of the glass-ceramic body 100. The refractive index-modified layer 400 may also be characterized as having an increased concentration of hydroxide as compared to the bulk of the glass-ceramic body 100.

In embodiments, the refractive index-modified layer 400 at a depth of 25 nm into the glass-ceramic body 100 from the first major surface 200 has a first glass-ceramic composition having a first refractive index and a first crystallinity, and at a midpoint depth 500 between the first major surface 200 and the second major surface 300 of the glass-ceramic body 100 a second glass-ceramic composition is present having a second refractive index and a second crystallinity. The first glass-ceramic composition of the refractive index-modified layer is different than the second glass-ceramic composition of the glass-ceramic body 100, and the first glass-ceramic composition and the second glass-ceramic composition may have different refractive indexes and crystallinity.

In embodiments, the first refractive index may be at least 0.01 less than the second refractive index. For example, the first refractive index may be at least 0.01, at least 0.02, at least 0.03, at least 0.04, at least 0.05, at least 0.06, at least 0.07, at least 0.08, at least 0.09, or at least 0.1 less than the second refractive index. In additional embodiments, the first refractive index may be at least 0.1, at least 0.15, at least 0.2, at least 0.25, at least 0.3, at least 0.35, at least 0.4, at least 0.45, or at least 0.5 less than the second refractive index. The refractive index may be measured by techniques known in the art, such as, for example, using an ellipsometer with silicon calibration standards.

In embodiments, the first crystallinity may be about 50% to about 90% of the second crystallinity. For example, the first crystallinity may be from about 50% to about 52%, from about 52% to about 54%, from about 54% to about 56%, from about 56% to about 58%, from about 58% to about 60%, from about 60% to about 62%, from about 62% to about 64%, from about 64% to about 66%, from about 66% to about 68%, from about 68% to about 70%, from about 70% to about 72%, from about 72% to about 74%, from about 74% to about 76%, from about 76% to about 78%, from about 78% to about 80%, from about 80% to about 82%, from about 82% to about 84%, from about 84% to about 86%, from about 86% to about 88%, from about 88% to about 90%, or any combination of one or more of these ranges. As used herein, the term “crystallinity” refers to the volume of crystal phase of the glass-ceramic composition and may be measured by Micro-Raman Spectroscopy. In the present disclosure, Micro-Raman Spectroscopy was performed using a Horiba LabRam HR Raman Spectrometer (dispersive) operated using Horiba LabSpec6 software and utilizing 532 nm laser excitation coupled to a confocal optical microscope and set-up for backscatter signal collection. The laser was operated with a power of 100 mW (~70 mW @sample) and was focused on predetermined locations utilizing a 100× magnification microscope objective resulting in a spatial resolution from ~1-2 μm³. Backscattered light from the predetermined location was collected and focused by the objective through razor edge filter, through a confocal hole, and into a dispersive spectrometer with an 1800 gr/mm grating coupled to a charge coupled device (CCD) detector. Samples were translated using motorized micrometric stage to perform 2 types of analyses, surface-confocal and cross-section evaluations. Surface evaluations are performed by focusing laser energy onto the surface of part and collecting the backscatter signal from the top 1-2 mm. Confocal depth evaluations are also performed by translating the sample in the z-direction (normal to excitation laser). Cross-section depth evaluations are performed by evaluating a fracture of polished slice (through thickness) which is analyzed with sample translation guarantees spatial depth resolution of 1 mm. The resulting Raman spectra were then processed identifying structural features which correlate to each phase (crystalline or amorphous) of interest. The intensity (or integrated area) of each band correlates to a concentration of vibrating species in the analysis volume and therefore total phase concentration. With reference standards (or w/XRD quantification) calibration procedures are performed to provide crystal (or amorphous) phase assemblage as a function of depth.

If present, the second refractive index-modified layer at a depth of 25 nm into the glass-ceramic body 100 from the second major surface may have a third glass-ceramic composition having a third refractive index and a third crystallinity. The third glass-ceramic composition may be the same or different than the first glass-ceramic composition. The third refractive index may be the same or different than the first refractive index. The third crystallinity may be the same or different than the first crystallinity.

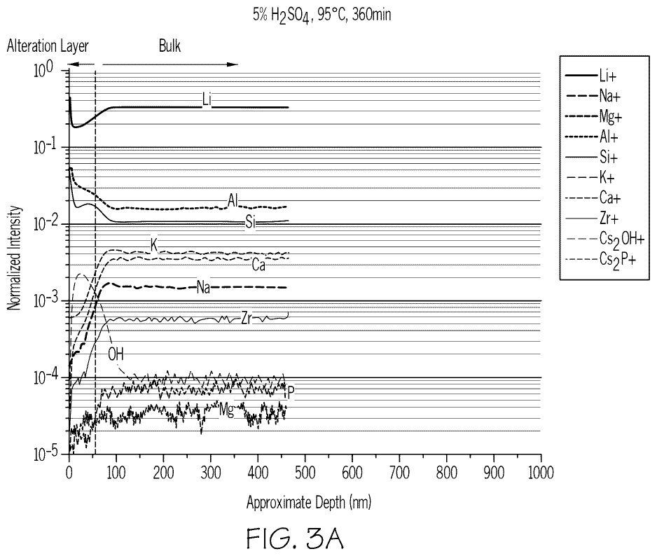

As discussed below, the refractive index-modified layer 400 may be produced by selectively leaching ions from at least the first major surface 200 of the glass-ceramic body 100 resulting in the formation of the refractive index-modified layer 400 adjacent to the first major surface 200. Without intending to be bound by theory, it is believed that hydronium ions from a leaching composition ion-exchange with alkali metal ions and other metal ions (e.g., zirconium) resulting in a refractive index-modified layer 400 having a reduced concentration of such ions. For example, FIG. 2 schematically depicts a glass-ceramic article prior to leaching (a) and after leaching (b). As shown in FIG. 2, the glass-ceramic article 10 includes an amorphous glassy layer that includes a ceramic phase and leachable ions throughout, and, after leaching, the smaller hydronium ions replace ions in the amorphous layer with the ceramic phase being uninterrupted. The change in the composition of the refractive index-modified layer 400 results in a reduced refractive index and crystallinity of the refractive index-modified layer 400, as well as an improved anti-reflective property as demonstrated by increased transmittance of the anti-reflective glass-ceramic article 10. Accordingly, the refractive index-modified layer 400 may also be referred to as a leaching layer.

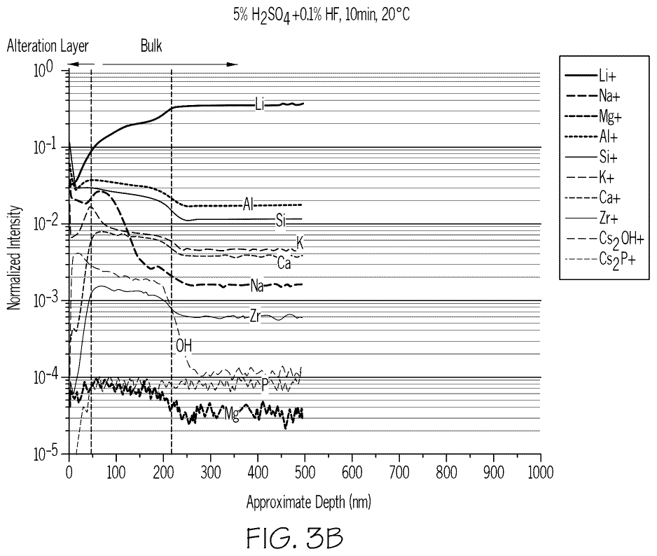

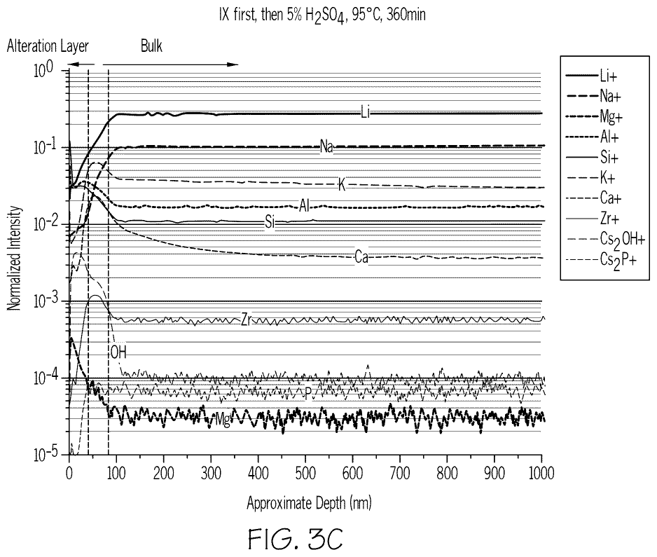

In embodiments, as shown in FIGS. 3A, 3B, and 3C, a concentration of hydroxide at a depth of 25 nm into the glass-ceramic body 100 from the first major surface 200 is at least about 25% greater, or at least about 50% greater, or at least about 75% greater, or at least about 100% greater, than a concentration of hydroxide at the midpoint depth 500 between the first major surface 200 and the second major surface 300, as measured by Secondary Ion Mass Spectrometry (SIMS).

In embodiments, as shown in FIGS. 3A, 3B, and 3C, a concentration of lithium at a depth of 25 nm into the glass-ceramic body 100 from the first major surface 200 is at least 5% less, or at least 10% less, or at least 15% less, than a concentration of lithium at the midpoint depth 500 between the first major surface 200 and the second major surface 300, as measured by Secondary Ion Mass Spectrometry (SIMS).

In embodiments, as shown in FIGS. 3A and 3C, a concentration of sodium at a depth of 25 nm into the glass-ceramic body 100 from the first major surface 200 is at least 25% less, or at least 30% less, or at least 40% less, than a concentration of sodium at a depth of 2 microns into the glass-ceramic body 100 from the first major surface 200, as measured by Secondary Ion Mass Spectrometry (SIMS).

In embodiments, as shown in FIGS. 3A and 3C, a concentration of potassium at a depth of 25 nm into the glass-ceramic body 100 from the first major surface 200 is at least 25% less, or at least 30% less, or at least 40% less, than a concentration of potassium at a depth of 2 microns into the glass-ceramic body from the first major surface 200, as measured by Secondary Ion Mass Spectrometry (SIMS).

In embodiments, as shown in FIGS. 3A and 3B, a concentration of calcium at a depth of 25 nm into the glass-ceramic body 100 from the first major surface 200 is at least 25% less, or at least 30% less, or at least 40% less, than a concentration of calcium at the midpoint depth 500 between the first major surface 200 and the second major surface 300, as measured by Secondary Ion Mass Spectrometry (SIMS).

In embodiments, as shown in FIGS. 3A, 3B, and 3C, a concentration of zirconium at a depth of 25 nm into the glass-ceramic body 100 from the first major surface 200 is at least 25% less, or at least 30% less, or at least 40% less, than a concentration of zirconium at the midpoint depth 500 between the first major surface 200 and the second major surface 300, as measured by Secondary Ion Mass Spectrometry (SIMS).

As used herein, SIMS (also referred to as D-SIMS to specify a dynamic measurement with depth profiling) refers to time-of-flight secondary ion mass spectrometry to analyze the chemical composition of a solid surface. SIMS is conducted using a time-of-flight secondary ion mass spectrometer (ToF-SIMS) with a dual beam configuration. In the present disclosure, the ToF-SIMS used for the results reported herein was a ToF-SIMS M6 instrument (available from IONTOF GmbH) equipped with a Nanoprobe50 bismuth source. The TOF-SIMS M6 instrument was operated with a dual-beam configuration, where the analysis beam was a 30 kilo-electron volt (keV) Bi₃⁺ beam with a current of about 0.1 pA and the sputter beam was 2 keV Cs⁺ with a current of about 120 nA. The sputter beam was configured from a 250 μm by 250 μm sputter “crater,” and the analysis beam was configured to impinge a 50 μm by 50 μm area centered in the sputter “crater.” Charge compensation was achieved using an electron flood gun operating with 20 pA beam current, 20 eV electron energy, and a 1.5 mm spot size focused on the location impinged by the analysis beam. The chamber was evacuated to a pressure of approximately 5×10⁻⁷ Pascals (5×10⁻⁹ millibar) before being brought to and maintained at a pressure of 6×10⁻⁵ Pascals (6×10⁻⁷ millibar) using argon (e.g., 99.99999% purity). Data was collected in positive ion mode with the analyzer in the “all purpose” mode, an analyzer energy of 3000 V and a cycle time of 100 microseconds. Data was acquired in a non-interlaced 3D measurement mode with an integer number of frames per cycle to have a sequence with approximately 1 second each for analysis, sputtering, and wait time. Data was processed using Surface Lab software (version 7.2.130677 available from IONTOF GmbH). To obtain relative depth vs concentration profiles for components of the glass-ceramic bulk and refractive index-modified layer 400, atomic ion species (e.g. Li⁺, Si⁺, Zr⁺, etc.) and Cs₂OH⁺ were used and depth scales were calibrated by measuring the final depth of sputter craters. Cs₂OH⁺ was selected to observe the dynamic concentration of subsurface hydrogen, without being bound by a confirmation of the structural state of hydrogen within the subsurface of the glass-ceramic. A normalized intensity was defined as the ratio of the ion signal divided by the total ion signal in each individual analysis cycle.

Although reference is made herein to a refractive index-modified layer 400 having a first glass-ceramic composition at a depth of 25 nm from the first major surface 200 of the glass-ceramic body 100, the composition of the refractive index-modified layer 400 is not constant throughout the depth of the layer. For example, as shown in FIGS. 3A, 3B, and 3C, the concentration of alkali metal ions and/or other metal ions are depleted near the first major surface 200 and increase through the depth of the glass-ceramic body 100 until they reach a near constant value at a depth where the bulk of the glass-ceramic body 100 begins. In contrast, as shown in FIGS. 3A, 3B, and 3C, the concentration of hydroxide ions (as a proxy for hydronium ions) is increased near the first major surface 200 and decreases through the depth of the glass-ceramic body 100 until they reach a near constant value at a depth where the bulk of the glass-ceramic body 100 begins. Accordingly, the composition of the refractive index-modified layer 400 will be dependent upon the depth from the first major surface 200 with the compositional gradient of alkali metal ions and/or other metal ions increasing as the depth increases and the composition gradient of hydroxide ions decreasing as the depth increases.

The anti-reflective glass-ceramic article 10 may have an average light transmittance over the optical wavelength regime from 450-650 nm of at least about 94% or greater, at least about 95%, at least about 96%, at least about 97%, at least about 98%, or at least about 99%, or greater, as measured according to ASTM D1003.

As used herein, the term “transmittance” is defined as the percentage of incident optical power within a given wavelength range transmitted through a material (e.g., the article, the substrate or portions thereof). Transmittance is measured using a specific linewidth. As used herein, an “average transmittance” refers to the average amount of incident optical power transmitted through a material over a defined wavelength regime. Unless otherwise specified, the average transmittance of the anti-reflective glass-ceramic article alone is measured at an incident illumination angle of 0 degrees relative to the first major surface (however, such measurements may be provided at incident illumination angles of 45 degrees or 60 degrees).

The anti-reflective glass-ceramic article 10 may also have relatively low haze. For example, the anti-reflective glass-ceramic article 10 may have a haze of less than 0.5%, or less than 0.3%, or less than 0.25%, as measured according to ASTM D1003.

As used herein, the term “haze” (also referred to as “transmission haze”) is a surface light scatter characteristic and refers to the percentage of light scattered outside an angular cone of 4.0° in accordance with ASTM procedure D1003.

The anti-reflective glass-ceramic article 10 may also have relatively low transmitted color shift. For example, the anti-reflective glass-ceramic article 10 may have CIE L*a*b* delta E* of less than about 2.5, less than about 2, less than about 1.5, less than about 1, less than about 0.5, less than about 0.2, less than about 0.1, or lower.

As used herein, “transmitted color” refers to the color transmitted through the anti-reflective glass-ceramic article with regard to color in the CIE L*, a*, b* colorimetry system under a D65 illuminant. More specifically, the “color shift” (i.e., as measured in transmission) is given by √(a*²+b*²), as these color coordinates are measured through transmission of a D65 illuminant through the first major surface and the second major surface of the anti-reflective glass-ceramic article over an incident angle range, e.g., from 0 degrees to 10 degrees.

The anti-reflective glass-ceramic article 10 may also have relatively good durability. For example, the anti-reflective glass-ceramic article 10 may have a removal value of less than 1,000 nm, or less than 500 nm, or less than 100 nm, or less than 50 nm. As used herein, “removal value” refers to the thickness of the glass-ceramic article that was removed by the leaching process. The removal value may be calculated by weighing the glass-ceramic body prior to leaching (M1), measuring the thickness of the glass-ceramic body prior to leaching (T1), subjecting the glass-ceramic body to the leaching process, measuring the weight of the glass-ceramic body post-leaching (M2), and calculating the removed thickness by the formula: (M1−M2)*T1/M1.

In some aspects, the anti-reflective glass-ceramic article, in addition to being transparent, can also be colored transparent, opaque, colored opaque, translucent, or colored translucent. As used herein “opaque” and “translucent” can mean as follows: opacity is the measure of impenetrability to visible light. An opaque object is neither transparent (allowing all light to pass through) nor translucent (allowing some light to pass through). When light strikes an interface between two substances, in general some may be reflected, some absorbed, some scattered, and the rest transmitted. An opaque substance transmits very little light, and therefore reflects, scatters, or absorbs most of it. Opacity depends on the frequency of the light being considered. For instance, some kinds of glass, while transparent in the visual range, are largely opaque to ultraviolet light. Further, the colored transparent, colored opaque, and colored translucent can be anyone of a variety of colors including, for example, black, white, green, yellow, pink, red, blue, orange, purple, brown etc.

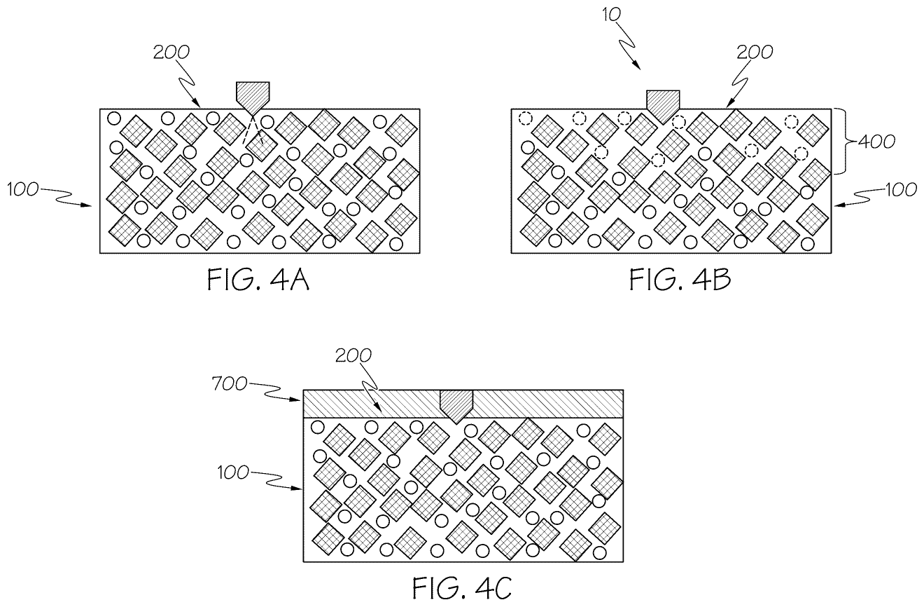

Without intending to be bound by theory, it is also believed that the replacement of alkali and other metal ions with hydronium ions in the refractive index-modified layer 400 results in improved durability of the anti-reflective glass-ceramic article 10 as the replacement of alkali and other metal ions with smaller hydronium ions allows for plastic deformation of the first major surface of the glass-ceramic body during a mechanical scratching event. For example, in FIG. 4 a hypothetical mechanical scratch event is simulated for (a) a glass-ceramic article without the refractive index-modified layer, (b) a glass-ceramic article 10 with a refractive index-modified layer 400 adjacent to the first major surface 200, and (c) a glass-ceramic article with an anti-reflective coating layer and no refractive index-modified layer. As shown, it is believed that the glass-ceramic article without the refractive index-modified layer (a) is brittle and susceptible to cracking during a mechanical scratching event, and the anti-reflective coating of (c) could be damaged and/or delaminated from the glass-ceramic article; however, the refractive index-modified layer 400 of the glass-ceramic article 10 in (c) could undergo plastic deformation and avoid visible defects that result in (a) and (b).

In embodiments, the glass-ceramic body 100 may be ion-exchanged. As used herein, the term “ion-exchanged glass-ceramic body” refers to a glass-ceramic body 100 that has been chemically strengthened through ion-exchange of larger alkali or metal ions for smaller alkali or metal ions in the surface of the substrate. As shown in FIG. 5, a glass-ceramic body 100 that has been ion-exchanged may also include an ion-exchanged layer 600 that extends from the first major surface 200 a thickness 610 that is greater than the thickness 410 of the refractive index-modified layer 400. The thickness 610 of the ion-exchanged layer 600 may be about 20% of the total thickness of the glass-ceramic body. The thickness 610 of the ion-exchanged layer 600 may be less than about 20% of the total thickness of the glass-ceramic body. The thickness 610 of the ion-exchanged layer 600 may be greater than about 20% of the total thickness of the glass-ceramic body. Methods for ion-exchange treatments are discussed in detail hereinbelow.

In some embodiments, as shown in FIG. 6, the glass-ceramic body 100 may comprise an easy-to-clean coating layer 700 disposed on the first major surface 200. The easy-to-clean coating 700 can be a fluorine-containing material. Alternatively, the easy-to-clean coating 700 (anti-fingerprint coating) can include a partial silica-like network having a ratio of Si—O—Si bonds to Si atoms in the coating from about 2 to about 3, the coating is fluorine-free, and the coating further comprises an alkyl silane at the exterior surface and bonded to Si—O groups in the anti-fingerprint coating. The easy-to-clean coating 700 may have a thickness in the range from about 5 nm to about 50 nm and may include known materials such as fluorinated or non-fluorinated silanes. The easy-to-clean coating 700 may alternately or additionally comprise a low-friction coating or surface treatment. Exemplary low-friction coating materials may include diamond-like carbon, silanes (e.g., fluorosilanes), phosphonates, alkenes, and alkynes. In some embodiments, the easy-to-clean coating 700 of may have a thickness in the range from about 1 nm to about 40 nm, from about 1 nm to about 30 nm, from about 1 nm to about 25 nm, from about 1 nm to about 20 nm, from about 1 nm to about 15 nm, from about 1 nm to about 10 nm, from about 5 nm to about 50 nm, from about 10 nm to about 50 nm, from about 15 nm to about 50 nm, from about 7 nm to about 20 nm, from about 7 nm to about 15 nm, from about 7 nm to about 12 nm, from about 7 nm to about 10 nm, from about 1 nm to about 90 nm, from about 5 nm to about 90 nm, from about 10 nm to about 90 nm, or from about 5 nm to about 100 nm, and all ranges and sub-ranges therebetween. Examples of a suitable anti-fingerprint hiding layer and easy-to-clean coatings are described in the following U.S. patent applications: U.S. Patent Application Publication No. 2014/0113083, published on Apr. 24, 2014, entitled “Process for Making of Glass Article 10 with Optical and Easy-to-Clean Coatings”; U.S. Provisional Patent Application No. 63/603,156, filed on Nov. 28, 2023, entitled “Coated Article 10s with a Surface-modifying layer 40 and Methods of Making the Same”; U.S. Provisional Patent Application No. 63/546,775, filed on Nov. 1, 2023, entitled “Coated Article 10s with a Planarization Layer and a Surface-modifying layer 40 and Methods of Making the Same”; and U.S. Non-Provisional patent application Ser. No. 18/528,916, filed on Dec. 5, 2023, entitled “Coated Article 10s with an Anti-Fingerprint Coating or Surface-modifying layer 40 and Methods of Making the Same”, all of which are incorporated herein by reference in their entirety.

As used herein, the term “dispose” includes coating, depositing, and/or forming a material onto a surface using any known or to be developed method in the art. The disposed material may constitute a layer, as defined herein. As used herein, the phrase “disposed on” includes forming a material onto a surface such that the material is in direct contact with the surface and embodiments where the material is formed on a surface with one or more intervening material(s) disposed between material and the surface. The intervening material(s) may constitute a layer, as defined herein.

In some embodiments, the glass-ceramic body 100 may have a texture on at least one of the first major surface 200 and the second major surface 300. Examples of textured articles, and methods for forming such textured articles, are disclosed in U.S. Pub. No. 2024/0391820 A1 and U.S. Pat. No. 11,940,593, the contents of which are incorporated herein by reference. As describe therein, according to some embodiments, a textured surface may be achieved by sand-blasting a glass-ceramic surface to form defects in the glass surface. In other embodiments, lithography may be utilized to form such defects. Following defect formation, the surfaces may be etched. In additional embodiments, laser processing may be utilized to achieve desired textures of the glass surface. Such textured surfaces may have increased surface roughness as compared to native drawn glass-ceramic substrates. Such texturing may increase tactile appeal and controllably enhance optical properties such as haze, as may be desired.

In some embodiments, the glass-ceramic body 100 does not have an anti-reflective coating 700 disposed on the first major surface 200. In some embodiments, the glass-ceramic body 100 does not have an anti-reflective coating 700 disposed on either of the first major surface 200 and the second major surface 300. In such embodiments, the first major surface may be an “air-side” surface contacting the air and defining the edge of the article.

The disclosure is also directed to a method of making an anti-reflective glass-ceramic article 10, the method comprising contacting a glass-ceramic body 100 with a leaching composition comprising one or more non-hydrofluoric acids, wherein the glass-ceramic body 100 comprises a first major surface 200 and a second major surface 300 opposite the first major surface 200 and the leaching composition contacts at least the first major surface 200, wherein at a depth of 25 nm into the body from the first major surface 200 a first glass-ceramic composition is present having a first refractive index and a first crystallinity, wherein at a midpoint depth 500 between the first major surface 200 and the second major surface 300 a second glass-ceramic composition is present having a second refractive index and a second crystallinity, wherein the first refractive index is at least 0.01 less than the second refractive index, and wherein the first crystallinity is about 50% to about 90% of the second crystallinity. The anti-reflect glass-ceramic article 10 made by the disclosed method may be the same as described above.

In embodiments, the method comprises contacting a glass-ceramic body 100 with a leaching composition comprising one or more non-hydrofluoric acids. The contacting of the glass-ceramic body 100 may be by immersion in the leaching composition or any other suitable technique.

The leaching composition may comprise an aqueous composition with one or more non-hydrofluoric acids. In some embodiments, the one or more non-hydrofluoric acids may comprise one or more acids having a pKa of less than about −1. For example, the one or more non-hydrofluoric acids may comprise one or more acids having a pKa of less than about −1 selected from the group, comprising, consisting essentially of, or consisting of sulfuric acid, hydrochloric acid, nitric acid, hydrobromic acid, hydroiodic acid, perchloric acid, and chloric acid. In some embodiments, the one or more non-hydrofluoric acids may comprise one or more acids having a pKa of greater than or equal to about −1. For example, the one or more non-hydrofluoric acids may comprise one or more acids having a pKa of greater than or equal to about −1 selected from the group, comprising, consisting essentially of, or consisting of citric acid and acetic acid.

In some embodiments, the one of more non-hydrofluoric acids may comprise at least about 1 wt. %, at least about 2 wt. %, at least about 5 wt. %, or more of the leaching composition, based on the total weight of the leaching composition. In some embodiments, the one of more non-hydrofluoric acids may comprise no more than about 50 wt. %, no more than about 25 wt. %, no more than about 10 wt. %, or less of the leaching composition, based on the total weight of the leaching composition. In some embodiments, the one of more non-hydrofluoric acids may comprise from about 1 wt. % to about 50 wt. % of the leaching composition, based on the total weight of the leaching composition, from about 2 wt. % to about 25 wt. %, from about 5 wt. % to about 10 wt. %, or any range or combination of ranges formed from these endpoints. The balance of the leaching composition may comprise an aqueous medium comprising at least water.

In some embodiments, the leaching composition may further comprise hydrofluoric acid (HF). Hydrofluoric acid may be present in the leaching composition in an amount of less than or equal to about 2,000 ppm, or less than or equal to about 1,000 ppm.

The contacting the glass-ceramic body 100 with the leaching composition may be for a period of from about 10 seconds to about 600 minutes, from about 10 seconds to about 360 minutes, from about 10 seconds to about 180 minutes, from about 10 seconds to about 60 minutes, from about 10 seconds to about 30 minutes, from about 10 seconds to about 10 minutes, from about 10 seconds to about 1 minute, from about 1 minute to about 600 minutes, from about 1 minute to about 360 minutes, from about 1 minute to about 180 minutes, from about 1 minute to about 60 minutes, from about 1 minute to about 10 minutes, from about 1 minute to about 30 minutes, from about 10 minutes to about 600 minutes, from about 10 minutes to about 360 minutes, from about 10 minutes to about 180 minutes, from about 10 minutes to about 60 minutes, from about 10 minutes to about 30 minutes, or any range or combination of ranges formed from these endpoints.

The temperature of the leaching composition during contact with the glass-ceramic body 100 may be at ambient temperature, such as about 20° C., or lower, or at elevated temperatures, such as at least about 50° C., at least about 75° C., at least about 90° C., at least about 94.7° C., or higher.

As discussed above, during contacting the glass-ceramic body 100 with the leaching composition it is believed that hydronium ions from the leaching composition ion exchange with at least one of lithium, sodium, potassium, calcium, and zirconium ion in the glass-ceramic body 100 reducing the concentration of at least one of lithium, sodium, potassium, calcium, and zirconium ions in the refractive index-modified layer 400 of the glass-ceramic body 100, and increasing the concentration of hydronium ions.

In embodiments, the method may further comprise ion-exchange processing the glass-ceramic body 100 prior to the contacting of the glass-ceramic body 100 with the leaching composition.

In embodiments, the method may further comprise ion-exchange processing the glass-ceramic body 100 following the contacting of the glass-ceramic body 100 with the leaching composition.

Ion-exchange processing results in an ion-exchanged glass-ceramic body 100 that is chemically strengthened through ion-exchange of larger ions for smaller ions in the surface of the substrate. The ion-exchange processing may be carried out by immersing a substrate in a molten salt bath containing the larger ions to be exchanged with the smaller ions in the glass-ceramic body 100. It will be appreciated by those skilled in the art that parameters for the ion exchange process, including, but not limited to, bath composition and temperature, immersion time, the number of immersions of the glass-ceramic body in a salt bath (or baths), use of multiple salt baths, additional steps such as annealing, washing, and the like, are generally determined by the composition of the glass-ceramic body 100 and the desired compressive stress (CS), depth of compressive stress layer (or depth of layer) of the glass-ceramic body 100 that results from the strengthening operation. By way of example, ion exchange of alkali metal-containing substrates may be achieved by immersion in at least one molten bath containing a salt such as, but not limited to, nitrates, sulfates, and chlorides of the larger alkali metal ion. The temperature of the molten salt bath typically is in a range from about 380° C. up to about 530° C., while immersion times range from about 15 minutes up to about 40 hours. However, temperatures and immersion times different from those described above may also be used. In some embodiments, the glass-ceramic body 100 may be subjected to more than one ion-exchange process. For example, a first ion exchange process can be carried out in a sodium-containing bath, exchanging sodium in the bath for lithium in the glass-ceramic body 100 to establish a depth of compression (DOC), while subsequently a second ion-exchange process is carried out on the same glass-ceramic body 100 in a potassium-containing bath to establish a depth of layer of potassium ions (DOL) and further increase the compressive stress in the glass-ceramic body near the surface.

In embodiments, the method may further comprise texturing the glass-ceramic body 100 prior to the contacting of the glass-ceramic body 100 with the leaching composition. Examples of such texturing is described hereinabove.

In one or more embodiments, the anti-reflective glass-ceramic article 10 may maintain abrasion resistance following leaching consistent with the same anti-reflective glass-ceramic article that has not undergone the leaching process. In one or more embodiments, for example, the anti-reflective glass-ceramic article 10 may exhibit a water contact angle following abrasion testing according to the Steel Wool Abrasion Test Method, as described in the Examples section herein below, of at least 1000 following 1,000 cycles, 2,000 cycles, or even 3,000 cycles, with a loading of 250 grams or even 500 grams.

The disclosure is also directed to a consumer electronic product comprising the anti-reflective glass-ceramic article 10 disclosed here. For example, the consumer electronic product may comprise a housing comprising a front surface, a back surface and side surfaces, electrical components at least partially within the housing, the electrical components comprising a controller, a memory, and a display, the display at or adjacent to the front surface of the housing, and a cover substrate disposed over the display, wherein at least one of a portion of the housing or the display comprises the anti-reflective glass-ceramic article disclosed herein. The consumer electronic product may comprise, for example, mobile phones, tablets, computers, navigation systems, wearable devices (e.g., watches) and the like.

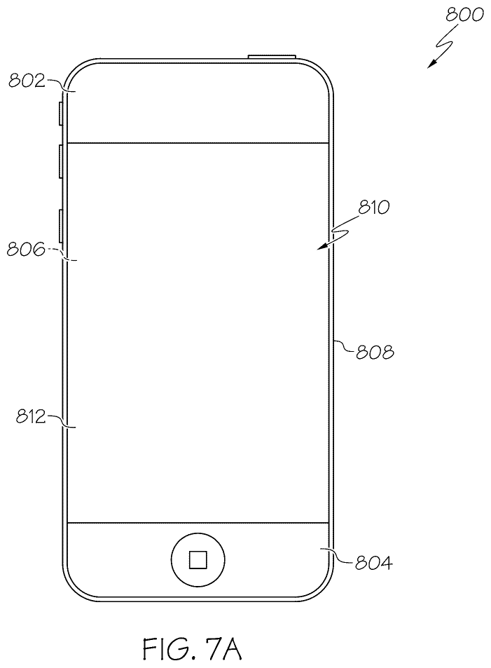

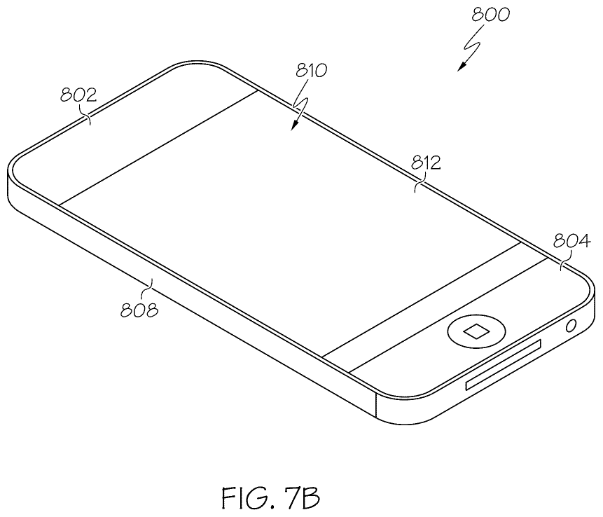

The anti-reflective glass-ceramic articles 10 disclosed herein may be incorporated into another article such as an article with a display (or display articles) (e.g., consumer electronics, including mobile phones, tablets, computers, navigation systems, and the like), architectural articles, transportation articles (e.g., automobiles, trains, aircraft, sea craft, etc.), appliance articles, or any other suitable article, or a combination thereof. An exemplary article incorporating any of the anti-reflective glass-ceramic article 10 disclosed herein is shown in FIGS. 7A and 7B. Specifically, FIGS. 7A and 7B show a consumer electronic device 800 including a housing 802 having front 804, back 806, and side surfaces 808; electrical components (not shown) that are at least partially inside or entirely within the housing and including at least a controller, a memory, and a display 810 at or adjacent to the front surface of the housing; and a cover substrate 812 at or over the front surface of the housing such that it is over the display. In embodiments, at least a portion of at least one of the cover substrate 812 and/or the housing 802 may include any of the anti-reflective glass-ceramic articles 10 disclosed herein.

In embodiments, anti-reflective glass-ceramic articles 10 disclosed herein may be incorporated into a structure, where the structure may comprise a transparent luminaire, transparent display, heads-up display, head-mounted display, transparent backlight, touch screen display, liquid-crystal display, aquarium, laser based reflective heads-up display, wearable display, window, vehicle dashboard, automotive window, waveguide, lightguide, or architectural window. In embodiments, the structure may comprise a microlens array, which may be used in applications such as optical and sensing systems. In embodiments, fabrication of microlens arrays with specific properties comprising anti-reflective glass-ceramic articles 10 disclosed herein may be adjusted not only by the shape of the glassy-phase regions but also by the local tuning of the refractive index. Further, anti-reflective glass-ceramic articles 10 disclosed herein may be used for metalenses, such as when the wavelengths of interest are larger than the lateral feature sizes.

The anti-reflective glass-ceramic articles 10 disclosed herein may be incorporated into a glass screen protector for a smart phone. The glass screen protector may comprise a cover glass and adhesive backing disposed on the cover glass. In embodiments, the adhesive backing is for attachment to the smart phone. In embodiments, at least one portion of the cover glass comprises any anti-reflective glass-ceramic article 10 disclosed herein.

### EXAMPLES

The following examples describe various features and advantages provided by the disclosure, and are in no way intended to limit the invention and appended claims.

### Example 1

Leaching compositions were prepared by combining water with the indicated amount of sulfuric acid, and, if present, hydrofluoric acid, at room temperature with sufficient mixing to combine the components with a slight exothermic reaction observed.

Some of the glass-ceramic bodies tested were a non-ion exchanged (NIX) glass ceramic material with a composition discussed above in Table 1 Example B, having dimensions of 50 mm by 50 mm with a thickness of 0.55 mm.

Some of the glass-ceramic bodies tested were ion exchanged (IX) glass ceramic material with a composition discussed above in Table 1 Example B, having dimensions of 50 mm by 50 mm with a thickness of 0.55 mm. The ion-exchange conditions for these parts using a molten salt composition comprising 40 wt % NaNO3, 60 wt % KNO3, 0.12 wt % LiNO3, 0.5 wt % silicic acid, an ion-exchange condition of 530° C. for 4.8 hours, and a loading density of 0.0125 m²/kg salt.

The glass-ceramic body was immersed in the leaching composition using a vertical static dipping process without agitation at either ambient (20° C.) or elevated (94.7° C.) temperature for the time indicated in the table below. For elevated temperatures, the leaching composition was heated using a digital hot block. Two glass-ceramic bodies were tested for each test condition.

| | | | Temperature | Time |
|---|---|---|---|---|
| Test # | GC Material | Leaching Composition | (° C.) | (min) |
| #1 | NIX | 5% H₂SO₄ | 95 | 30 |
| | Example B | | | |
| #2 | NIX | 5% H₂SO₄ | 95 | 60 |
| | Example B | | | |
| #3 | NIX | 5% H₂SO₄ | 95 | 360 |
| | Example B | | | |
| #4 | NIX | 2500 ppm HF, 5% H₂SO₄ | 20 | 1 |
| | Example B | | | |
| #5 | NIX | 2500 ppm HF, 5% H₂SO₄ | 20 | 10 |
| | Example B | | | |
| #6 | NIX | 500 ppm HF, 5% H₂SO₄ | 20 | 1 |
| | Example B | | | |
| #7 | NIX | 500 ppm HF, 5% H₂SO₄ | 20 | 10 |
| | Example B | | | |
| #8 | NIX | 500 ppm HF | 20 | 1 |
| | Example B | | | |
| #9 | NIX | 500 ppm HF | 20 | 10 |
| | Example B | | | |
| #12 | IX Example | 5% H₂SO₄ | 95 | 360 |
| | B | | | |
| #13 | IX Example | 500 ppm HF, 5% H₂SO₄ | 20 | 10 |
| | B | | | |

Following immersion, the glass-ceramic body was rinsed with deionized water and allowed to dry.

The glass-ceramic body was then tested for average transmittance, haze, and transmitted color shift. The transmittance and haze were tested using a BYK Haze Gard according to ASTM D1003. The transmitted color shift was tested using a CM-3700 spectrophotometer.

The leached glass-ceramic body was also tested for removal by weighing the glass-ceramic body prior to leaching (M1), measuring the thickness of the glass-ceramic body prior to leaching (T1), subjecting the glass-ceramic body to the leaching process, measuring the weight of the glass-ceramic body post-leaching (M2), and calculating the removed thickness by the formula: (M1−M2)*T1/M1.

The results of the testing are provided in the table below.

| | | Contact | Initial | | | | | | | |
|---|---|---|---|---|---|---|---|---|---|---|
| | Leaching | time | Temp | | H | L* | a* | b* | Delta | Removal |
| Ex. | Comp. | (min) | (° C.) | T (%) | (%) | (D65) | (D65) | (D65) | E | (nm) |
| 1-1 | 5% | 30 | 94.7 | 94.40 | 0.23 | 96.97 | −0.11 | 0.33 | 0.38 | n/a |
| | H2SO4 | | | | | | | | | |
| 1-2 | 5% | 30 | 94.7 | 94.40 | 0.25 | 96.96 | −0.11 | 0.33 | 0.37 | 16 |
| | H2SO4 | | | | | | | | | |
| 2-1 | 5% | 60 | 94.7 | 94.49 | 0.19 | 97.03 | −0.1 | 0.49 | 0.47 | 8 |
| | H2SO4 | | | | | | | | | |
| 2-2 | 5% | 60 | 94.7 | 94.50 | 0.25 | 97.02 | −0.1 | 0.48 | 0.45 | 24 |
| | H2SO4 | | | | | | | | | |
| 3-1 | 5% | 360 | 94.7 | 95.99 | 0.15 | 97.69 | −0.09 | −0.44 | 1.35 | 16 |
| | H2SO4 | | | | | | | | | |
| 3-2 | 5% | 360 | 94.7 | 95.80 | 0.22 | 97.63 | −0.09 | −0.42 | 1.29 | 32 |
| | H2SO4 | | | | | | | | | |
| 4-1 | 2500 | 1 | 20 | 97.55 | 0.11 | 98.39 | −0.26 | −0.41 | 1.96 | 24 |
| | ppm | | | | | | | | | |
| | HF/5% | | | | | | | | | |
| | H2SO4 | | | | | | | | | |
| 4-2 | 2500 | 1 | 20 | 97.48 | 0.09 | 98.4 | −0.25 | −0.42 | 1.97 | 40 |
| | ppm | | | | | | | | | |
| | HF/5% | | | | | | | | | |
| | H2SO4 | | | | | | | | | |
| 5-1 | 2500 | 10 | 20 | 97.97 | 0.66 | 98.88 | −0.09 | −0.31 | 2.38 | 449 |
| | ppm | | | | | | | | | |
| | HF/5% | | | | | | | | | |
| | H2SO4 | | | | | | | | | |
| 5-2 | 2500 | 10 | 20 | 98.07 | 0.60 | 98.89 | −0.2 | −0.36 | 2.41 | 447 |
| | ppm | | | | | | | | | |
| | HF/5% | | | | | | | | | |
| | H2SO4 | | | | | | | | | |
| 6-1 | 500 ppm | 1 | 20 | 93.68 | 0.13 | 96.66 | −0.07 | 0.28 | 0.09 | 0 |
| | HF/5% | | | | | | | | | |
| | H2SO4 | | | | | | | | | |
| 6-2 | 500 ppm | 1 | 20 | 93.67 | 0.13 | 96.66 | −0.08 | 0.28 | 0.09 | 0 |
| | HF/5% | | | | | | | | | |
| | H2SO4 | | | | | | | | | |
| 7-1 | 500 ppm | 10 | 20 | 98.26 | 0.09 | 98.74 | −0.29 | −0.37 | 2.27 | 0 |
| | HF/5% | | | | | | | | | |
| | H2SO4 | | | | | | | | | |
| 7-2 | 500 ppm | 10 | 20 | 98.25 | 0.08 | 98.7 | −0.28 | −0.39 | 2.24 | 24 |
| | HF/5% | | | | | | | | | |
| | H2SO4 | | | | | | | | | |
| 8-1 | 500 ppm | 1 | 20 | 100.21 | 0.07 | 99.62 | −0.33 | 0.29 | 3.04 | 64 |
| | HF | | | | | | | | | |
| 8-2 | 500 ppm | 1 | 20 | 100.17 | 0.08 | 99.62 | −0.32 | 0.3 | 3.04 | 72 |
| | HF | | | | | | | | | |
| 9-1 | 500 ppm | 10 | 20 | 98.10 | 1.50 | 98.7 | −0.49 | −0.39 | 2.27 | 840 |
| | HF | | | | | | | | | |
| 9-2 | 500 ppm | 10 | 20 | 98.08 | 1.44 | 98.72 | −0.58 | −0.5 | 2.35 | 847 |
| | HF | | | | | | | | | |
| NIX | — | — | — | 93.52 | 0.13 | 96.59 | −0.07 | 0.34 | 0.00 | — |
| Con. | | | | | | | | | | |
| NIX | — | — | — | 93.52 | 0.13 | 96.59 | −0.07 | 0.34 | 0.00 | — |
| Con. | | | | | | | | | | |
| 12- | 5% | 360 | 94.7 | 97.01 | 0.14 | 98.158 | −0.22 | −0.33 | 1.75 | — |
| IX | H2SO4 | | | | | | | | | |
| 13- | 500 ppm | 10 | 20 | 99.78 | 0.1 | 99.504 | −0.242 | 0.792 | 2.97 | — |
| IX | HF/5% | | | | | | | | | |
| | H2SO4 | | | | | | | | | |
| IX | — | — | — | 93.45 | 0.12 | 96.56 | −0.07 | 0.37 | 0.12 | — |
| Con. | | | | | | | | | | |
| IX | — | — | — | 93.48 | 0.12 | 96.58 | −0.07 | 0.36 | 0.12 | — |
| Con. | | | | | | | | | | |

### Example 2

The impact of the leaching procedure on abrasion resistance was also evaluated. The glass-ceramic bodies used in this testing were glass ceramic material with a composition discussed above in Table 1 Example B, having dimensions of 50 mm by 50 mm with a thickness of 0.55 mm. The surface of the glass-ceramic body to be tested was also textured using a sandblast and etch process. The samples were then subjected to the blasting conditions in the below table utilizing SiC abrasive particles to form abraded samples.

| Condition | | |
|---|---|---|
| Particle Size | 1000 | mesh |
| Nozzle Distance | 4 | inches |
| Angle | 0° | |
| Time | 4 | minutes |

The abraded samples were then etched with an aqueous solution containing 70 wt % NaOH at a temperature of 170° C. for a time period of 2 hours.

Following texturing, a portion of the glass-ceramic bodies were treated with a leaching composition that included 500 ppm HF and 5% H₂SO₄ at ambient temperature (20° C.). The glass-ceramic body was immersed in the leaching composition using a vertical static dipping process without agitation for 10 minutes. Two glass-ceramic bodies were tested for each test condition.

Following leaching or texturing for the non-leched examples, the glass-ceramic bodies were ion exchanged (IX). The ion-exchange conditions for these glass-ceramic bodies used a molten salt composition comprising 40 wt % NaNO3, 60 wt % KNO3, 0.12 wt % LiNO3, 0.5 wt % silicic acid, an ion-exchange condition of 530° C. for 4.8 hours, and a loading density of 0.0125 m²/kg salt.

Following ion exchanging, the textured surface of each of the glass-ceramic bodies were coated with a thin layer of anti-fingerprint (AF) coating (Daikin UD509).

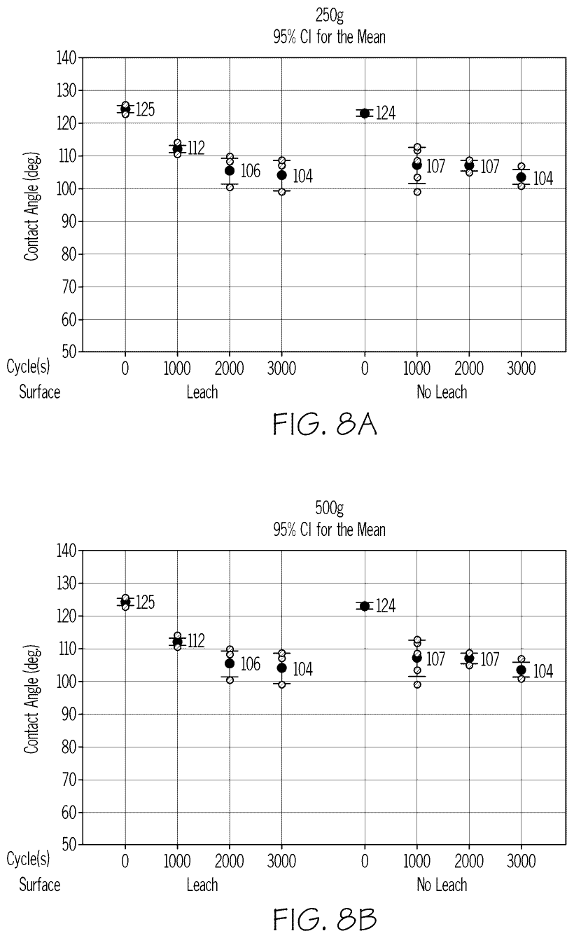

The prepared glass-ceramic bodies were evaluated for abrasion using the Steel Wool Abrasion Test Method. The Steel Wool Abrasion Test Method used Bonstar 0000 grade steel wool pads with dimensions of 40 mm×40 mm. The abrasion process is conducted with a stroke length of 25 mm at a rate of 60 cycles per minute with a constant load of either 250 grams or 500 grams. To ensure consistent abrasion conditions, the steel wool pad is replaced every 1000 cycles. A 1 μL drop of testing liquid was applied evenly to the surface of the sample prior to abrasion. The surface was evaluated using a 3-point measurement method after the abrasion procedure was completed. The results for the 250 grams load are presented in FIG. 8A and the results for the 500 grams load are presented in FIG. 8B. The results are presented for the initial water contact angle prior to any abrasion (i.e., 0 cycles), 1,000 cycles, 2,000 cycles, and 3,000 cycles for the leached and non-leached substrates for both load values tested. The results show no significant difference between the glass-ceramic bodies subjected to the leaching procedure and those that were not subjected to the leaching procedure indicating that the leaching procedure had no impact positively or negatively on the abrasion resistance of the glass-ceramic body.

In a first aspect of the present disclosure, an anti-reflective glass-ceramic article comprising a glass-ceramic body comprising a first major surface, a second major surface opposite the first major surface, and a refractive index-modified layer positioned adjacent the first major surface and extending into a thickness of the glass-ceramic body; wherein within the refractive index-modified layer at a depth of 25 nm into the glass-ceramic body from the first major surface a first glass-ceramic composition is present having a first refractive index and a first crystallinity; wherein at a midpoint depth between the first major surface and the second major surface a second glass-ceramic composition is present having a second refractive index and a second crystallinity; wherein the first refractive index is at least 0.01 less than the second refractive index; and wherein the first crystallinity is about 50% to about 90% of the second crystallinity.

A second aspect of the present disclosure may include the first aspect, wherein a concentration of hydroxide at a depth of 25 nm into the glass-ceramic body from the first major surface is at least 25% greater than a concentration of hydroxide at the midpoint depth between the first major surface and the second major surface, as measured by Secondary Ion Mass Spectrometry (SIMS).

A third aspect of the present disclosure may include either the first or second aspect, wherein a concentration of lithium at a depth of 25 nm into the glass-ceramic body from the first major surface is at least 5% less than a concentration of lithium at the midpoint depth between the first major surface and the second major surface, as measured by Secondary Ion Mass Spectrometry (SIMS).

A fourth aspect of the present disclosure may include any of the first through third aspects, wherein a concentration of sodium at a depth of 25 nm into the glass-ceramic body from the first major surface is at least 25% less than a concentration of sodium at a depth of 2 microns into the glass-ceramic body from the first major surface, as measured by Secondary Ion Mass Spectrometry (SIMS).

A fifth aspect of the present disclosure may include any of the first through fourth aspects, wherein a concentration of potassium at a depth of 25 nm into the glass-ceramic body from the first major surface is at least 25% less than a concentration of potassium at a depth of 2 microns into the glass-ceramic body from the first major surface, as measured by Secondary Ion Mass Spectrometry (SIMS).

A sixth aspect of the present disclosure may include any of the first through fifth aspects, wherein a concentration of calcium at a depth of 25 nm into the glass-ceramic body from the first major surface is at least 25% less than a concentration of calcium at the midpoint depth between the first major surface and the second major surface, as measured by Secondary Ion Mass Spectrometry (SIMS).

A seventh aspect of the present disclosure may include any of the first through sixth aspects, wherein a concentration of zirconium at a depth of 25 nm into the glass-ceramic body from the first major surface is at least 25% less than a concentration of zirconium at the midpoint depth between the first major surface and the second major surface, as measured by Secondary Ion Mass Spectrometry (SIMS).

An eighth aspect of the present disclosure may include any of the first through seventh aspects, wherein the refractive index-modified layer is present from the first major surface to a depth of 1 micron or less.

A ninth aspect of the present disclosure may include any of the first through eighth aspects, wherein the refractive index-modified layer is a leaching layer.

A tenth aspect of the present disclosure may include any of the first through ninth aspects, wherein the glass-ceramic body does not have an anti-reflective coating disposed on the first major surface.

An eleventh aspect of the present disclosure may include any of the first through tenth aspects, wherein the glass-ceramic body comprises an easy-to-clean coating layer disposed on the first major surface.

A twelfth aspect of the present disclosure may include any of the first through eleventh aspects, wherein the glass-ceramic body has been ion-exchanged.

A thirteenth aspect of the present disclosure may include any of the first through twelfth aspects, wherein anti-reflective glass-ceramic article has an average light transmittance of at least 94%, as measured according to ASTM D1003.

A fourteenth aspect of the present disclosure may include any of the first through thirteenth aspects, wherein anti-reflective glass-ceramic article has a haze of less than 0.5%, as measured according to ASTM D1003.

A fifteenth aspect of the present disclosure may include any of the first through fourteenth aspects, wherein the CIE L*a*b* delta E* is less than about 2.5.

A sixteenth aspect of the present disclosure may include any of the first through fifteenth aspects, wherein the anti-reflective glass-ceramic article has a removal value of less than 1,000 nm.

A seventeenth aspect of the present disclosure may include any of the first through sixteenth aspects, wherein the first refractive index is from 0.01 to 0.5 less than the second refractive index.

An eighteenth aspect of the present disclosure may include any of the first through seventeenth aspects, wherein the glass-ceramic body consists essentially of the following composition: 68-72 mol % SiO₂; 3-5 mol % Al₂O₃; 0.6-1.2 mol % P₂O₅; 17-25 mol % Li₂O; 0.01-1.7 mol % Na₂O; 0-5 mol % B₂O₃; 0.01-0.5 mol % K₂O; 1.5-3 mol % ZrO₂; 0.01-0.1 mol % SnO₂; 0.01-0.1 mol % HfO₂; and 0.01-0.5 mol % Fe₂O₃; and wherein the glass-ceramic body further comprises the following phase assemblage: 10-21 wt. % glass; 40-50 wt. % lithium disilicate (Li₂Si₂O₅); 35-45 wt. % petalite (LiAlSi₄O₁₀); and <2 wt. % of other phases.

A nineteenth aspect of the present disclosure may include any of the first through eighteenth aspects, wherein the glass-ceramic body has a texture on at least one of the first major surface and second major surface.

In a twentieth aspect of the present disclosure, a method of making an anti-reflective glass-ceramic article, the method comprising: contacting a glass-ceramic body with a leaching composition comprising one or more non-hydrofluoric acids; wherein the glass-ceramic body comprises a first major surface and a second major surface opposite the first major surface and the leaching composition contacts at least the first major surface, wherein at a depth of 25 nm into the body from the first major surface a first glass-ceramic composition is present having a first refractive index and a first crystallinity; wherein at a midpoint depth between the first major surface and the second major surface a second glass-ceramic composition is present having a second refractive index and a second crystallinity; wherein the first refractive index is at least 0.001 less than the second refractive index; and wherein the first crystallinity is about 50% to about 90% of the second crystallinity.

A twenty-first aspect of the present disclosure may include the twentieth aspect, wherein hydronium ions from the leaching composition ion exchange with at least one of lithium, sodium, potassium, calcium, and zirconium ions in the glass-ceramic body reducing the concentration of the at least one of lithium, sodium, potassium, and zirconium ions in the glass-ceramic body.

A twenty-second aspect of the present disclosure may include the twentieth aspect or twenty-first aspect, wherein the leaching composition comprises the one or more non-hydrofluoric acids in an amount of about 1 wt. % to about 50 wt. %, based on the total weight of the leaching composition.

A twenty-third aspect of the present disclosure may include any of the twentieth to twenty-second aspects, wherein contacting the glass-ceramic body with the leaching composition is for a period of 10 seconds through 600 minutes.

A twenty-fourth aspect of the present disclosure may include any of the twentieth to twenty-third aspects, wherein the one or more non-hydrofluoric acids comprise one or more acids having a pKa of less than about −1.

A twenty-fifth aspect of the present disclosure may include any of the twentieth to twenty-fourth aspects, wherein the one or more non-hydrofluoric acids is selected from the group consisting of sulfuric acid, hydrochloric acid, nitric acid, hydrobromic acid, hydroiodic acid, perchloric acid, and chloric acid.

A twenty-sixth aspect of the present disclosure may include any of the twentieth to twenty-fifth aspects, wherein the one or more non-hydrofluoric acids comprise one or more acids having a pKa of greater than or equal to about −1.

A twenty-seventh aspect of the present disclosure may include any of the twentieth to twenty-sixth aspects, wherein the one or more non-hydrofluoric acids comprise citric acid, acetic acid, or a combination thereof.

A twenty-eighth aspect of the present disclosure may include any of the twentieth to twenty-seventh aspects, wherein the one or more non-hydrofluoric acids comprise sulfuric acid, hydrochloric acid, nitric acid, hydrobromic acid, hydroiodic acid, perchloric acid, chloric acid, citric acid, acetic acid, or a combination thereof.

A twenty-ninth aspect of the present disclosure may include any of the twentieth to twenty-eighth aspects, wherein the leaching composition further comprises hydrofluoric acid.

A thirtieth aspect of the present disclosure may include any of the twentieth to twenty-ninth aspects, wherein the hydrofluoric acid is present in the leaching composition in an amount of less than or equal to about 2,000 ppm.

A thirty-first aspect of the present disclosure may include any of the twentieth to thirtieth aspects, further comprising ion-exchange processing the glass-ceramic body prior to the contacting of the glass-ceramic body with the leaching composition.

A thirty-second aspect of the present disclosure may include any of the twentieth to thirty-first aspects, further comprising ion-exchange processing the glass-ceramic body following the contacting of the glass-ceramic body with the leaching composition.

A thirty-third aspect of the present disclosure may include any of the twentieth to thirty-second aspects, further comprising texturing the glass-ceramic body prior to the contacting of the glass-ceramic body with the leaching composition.

A thirty-fourth aspect of the present disclosure may include any of the twentieth to thirty-third aspects, wherein the texturing further comprising (1) sandblasting the glass-ceramic body or (2) masking and performing a photolithography process on the glass-ceramic body.

A thirty-fifth aspect of the present disclosure may include any of the twentieth to thirty-fourth aspects, wherein after contacting the anti-reflective glass-ceramic article with the leaching composition, the anti-reflective glass-ceramic article has: an average light transmittance of at least 94%, as measured according to ASTM D1003; a haze of less than 0.5%, as measured according to ASTM D1003; a CIEL*a*b* delta E* of less than about 2.5; and a removal value of less than 1,000 nm.

A thirty-sixth aspect of the present disclosure, consumer electronic product, comprising: a housing comprising a front surface, a back surface and side surfaces; electrical components at least partially within the housing, the electrical components comprising a controller, a memory, and a display, the display at or adjacent to the front surface of the housing; and a cover substrate disposed over the display, wherein at least one of a portion of the housing or the display comprises the anti-reflective glass-ceramic article of any of the first to nineteenth aspects.

Although multiple embodiments of the present disclosure have been illustrated in the accompanying Drawings and described in the foregoing Detailed Description, it should be understood that the invention is not limited to the disclosed embodiments, but instead is also capable of numerous rearrangements, modifications, and substitutions without departing from the present disclosure that has been set forth and defined within the following claims.

What is claimed is:

1. An anti-reflective glass-ceramic article comprising:
a glass-ceramic body comprising a first major surface, a second major surface opposite the first major surface, and a refractive index-modified layer positioned adjacent the first major surface and extending into a thickness of the glass-ceramic body;
wherein within the refractive index-modified layer at a depth of 25 nm into the glass-ceramic body from the first major surface a first glass-ceramic composition is present having a first refractive index and a first crystallinity;
wherein at a midpoint depth between the first major surface and the second major surface a second glass-ceramic composition is present having a second refractive index and a second crystallinity;
wherein the first refractive index is at least 0.01 less than the second refractive index; and
wherein the first crystallinity is about 50% to about 90% of the second crystallinity.

2. The anti-reflective glass-ceramic article of claim 1, wherein a concentration of hydroxide at a depth of 25 nm into the glass-ceramic body from the first major surface is at least 25% greater than a concentration of hydroxide at the midpoint depth between the first major surface and the second major surface, as measured by Secondary Ion Mass Spectrometry (SIMS).

3. The anti-reflective glass-ceramic article of claim 1, wherein a concentration of lithium at a depth of 25 nm into the glass-ceramic body from the first major surface is at least 5% less than a concentration of lithium at the midpoint depth between the first major surface and the second major surface, as measured by Secondary Ion Mass Spectrometry (SIMS).

4. The anti-reflective glass-ceramic article of claim 1, wherein a concentration of sodium at a depth of 25 nm into the glass-ceramic body from the first major surface is at least 25% less than a concentration of sodium at a depth of 2 microns into the glass-ceramic body from the first major surface, as measured by Secondary Ion Mass Spectrometry (SIMS).

5. The anti-reflective glass-ceramic article of claim 1, wherein a concentration of potassium at a depth of 25 nm into the glass-ceramic body from the first major surface is at least 25% less than a concentration of potassium at a depth of 2 microns into the glass-ceramic body from the first major surface, as measured by Secondary Ion Mass Spectrometry (SIMS).

6. The anti-reflective glass-ceramic article of claim 1, wherein a concentration of calcium at a depth of 25 nm into the glass-ceramic body from the first major surface is at least 25% less than a concentration of calcium at the midpoint depth between the first major surface and the second major surface, as measured by Secondary Ion Mass Spectrometry (SIMS).

7. The anti-reflective glass-ceramic article of claim 1, wherein a concentration of zirconium at a depth of 25 nm into the glass-ceramic body from the first major surface is at least 25% less than a concentration of zirconium at the midpoint depth between the first major surface and the second major surface, as measured by Secondary Ion Mass Spectrometry (SIMS).

8. The anti-reflective glass-ceramic article of claim 1, wherein the refractive index-modified layer is present from the first major surface to a depth of 1 micron or less.

9. The anti-reflective glass-ceramic article of claim 1, wherein the refractive index-modified layer is a leaching layer.

10. The anti-reflective glass-ceramic article of claim 1, wherein the glass-ceramic body does not have an anti-reflective coating disposed on the first major surface.

11. The anti-reflective glass-ceramic article of claim 1, wherein the glass-ceramic body comprises an easy-to-clean coating layer disposed on the first major surface.

12. The anti-reflective glass-ceramic article of claim 1, wherein the glass-ceramic body has been ion-exchanged.

13. The anti-reflective glass-ceramic article of claim 1, wherein the anti-reflective glass-ceramic article has an average light transmittance of at least 94%, as measured according to ASTM D1003.

14. The anti-reflective glass-ceramic article of claim 1, wherein the anti-reflective glass-ceramic article has a haze of less than 0.5%, as measured according to ASTM D1003.

15. The anti-reflective glass-ceramic article of claim 1, wherein the CIE L*a*b* delta E* is less than about 2.5.

16. The anti-reflective glass-ceramic article of claim 1, wherein the anti-reflective glass-ceramic article has a removal value of less than 1,000 nm.

17. The anti-reflective glass-ceramic article of claim 1, wherein the first refractive index is from 0.01 to 0.5 less than the second refractive index.

18. The anti-reflective glass-ceramic article of claim 1, wherein the glass-ceramic body consists essentially of the following composition:
68-72 mol % SiO₂;
3-5 mol % Al₂O₃;
0.6-1.2 mol % P₂O₅;
17-25 mol % Li₂O;
0.01-1.7 mol % Na₂O;
0-5 mol % B₂O₃;
0.01-0.5 mol % K₂O;
1.5-3 mol % ZrO₂;
0.01-0.1 mol % SnO₂;
0.01-0.1 mol % HfO₂;
0.01-0.5 mol % Fe₂O₃; and
wherein the glass-ceramic body further comprises the following phase assemblage:
10-21 wt. % glass;
40-50 wt. % lithium disilicate (Li₂Si₂O₅);
35-45 wt. % petalite (LiAlSi₄O₁₀); and
<2 wt. % of other phases.

19. The anti-reflective glass-ceramic article of claim 1, wherein the glass-ceramic body has a texture on at least one of the first major surface and second major surface.

20. The anti-reflective glass-ceramic article of claim 19, wherein the anti-reflective glass-ceramic article exhibits a water contact angle of at least 1000 following 3,000 cycles with a loading of 500 grams as tested according to the Steel Wool Abrasion Test Method.

21. The anti-reflective glass-ceramic article of claim 1, further comprising a second refractive index-modified layer adjacent the second major surface;
wherein within the second refractive index-modified layer at a depth of 25 nm into the glass-ceramic body from the second major surface a third glass-ceramic composition is present having a third refractive index and a third crystallinity;
wherein the third refractive index is at least 0.01 less than the second refractive index; and
wherein the third crystallinity is about 50% to about 90% of the second crystallinity.

22. A method of making an anti-reflective glass-ceramic article, the method comprising:
contacting a glass-ceramic body with a leaching composition comprising one or more non-hydrofluoric acids;
wherein the glass-ceramic body comprises a first major surface and a second major surface opposite the first major surface and the leaching composition contacts at least the first major surface,
wherein at a depth of 25 nm into the body from the first major surface a first glass-ceramic composition is present having a first refractive index and a first crystallinity;
wherein at a midpoint depth between the first major surface and the second major surface a second glass-ceramic composition is present having a second refractive index and a second crystallinity;
wherein the first refractive index is at least 0.001 less than the second refractive index; and
wherein the first crystallinity is about 50% to about 90% of the second crystallinity.

23. A consumer electronic product, comprising:
a housing comprising a front surface, a back surface and side surfaces;
electrical components at least partially within the housing, the electrical components comprising a controller, a memory, and a display, the display at or adjacent to the front surface of the housing; and
a cover substrate disposed over the display,
wherein at least one of a portion of the housing or the display comprises the anti-reflective glass-ceramic article of claim 1.
